(19) United States
(12) Patent Application Publication
(10) Pub. No.: US 2005/0193729 A1
(43) Pub. Date: Sep. 8, 2005

(54) Trinity hydro-pneumatic power source

(76) Inventors: Suthep Vichakyothin, Bangkok (TH); Ekepand Dirkul, Leay Province (TH)

Correspondence Address: GOLD & RIZVI, P.A., 600 N. PINE ISLAND ROAD, SUITE 450, PLANTATION, FL, 33324-1311, US

(21) Appl. No.: 11/036,451

(22) Filed: Jan. 14, 2005

(30) Foreign Application Priority Data
Jan. 14, 2004 (TH) 087961

(51) Int. Cl. F16D 31/02

(52) U.S. Cl. 60/413

(57) ABSTRACT

A trinity hydro-pneumatic power source preferably includes a turbine, three hydro-pneumatic pressure tanks, a pneumatic pressure tank, a vacuum pump, a compression pump and a valve controller. The turbine is optimized to receive a flow of pressurized water through a water nozzle. The water nozzle receives pressurized water from one of the three hydro-pneumatic pressure tanks. The pneumatic pressure tank is used to force water out of the three hydro-pneumatic pressure tanks. The vacuum pump is used to form a vacuum in the hydro-pneumatic pressure tank, before being filled with water. A compression pump receives pressurized air from one of the three hydro-pneumatic pressure tanks to build pressure for input into the pneumatic pressure tank. The valve controller actuates a plurality of valves for operating the trinity hydro-pneumatic power source.

### CROSS-REFERENCE TO RELATED APPLICATIONS

This application claims the priority of co-pending Thai patent application Serial Number 087961, filed on Jan. 14, 2005.

### BACKGROUND OF THE INVENTION

1. Field of the Invention

The present invention relates generally to electric power generation and more particularly, to a trinity hydro-pneumatic power source, which does not solely rely on hydraulics to generate mechanical rotational motion.

2. Description of the Prior Art

For hundreds of years creating electric power was accomplished by converting the force generated by falling water into mechanical rotational motion. The rotational motion came from the rotation of some type of paddle wheel, such as a turbine. Cups on the perimeter of the turbine receive falling water that causes the turbine to rotate and produce rotational energy through a shaft. The shaft is coupled to an electric generator. Fluid under pressure is known as Hydraulics. Electric generating power plants are known as Hydroelectric Power plants.

Pneumatics is a technique of compressing air to force the movement of an object. The most common application of pneumatics is the air cylinder. Pressurized air is used to move a piston inside a cylinder. A rod extends from the piston through an end of the cylinder. The release of pressurized air into the cylinder cavity causes the rod to move from a first position to a second position. However, either pneumatic power or hydraulic power is used in a system to create motion. It appears that pneumatic power and hydraulic power are not used together in the same system, unless there are separate applications for each method.

Accordingly, there is an established need for a trinity hydro-pneumatic power source, which combines pneumatics and hydraulics to produce mechanical rotational motion that may be used to drive an electric generator.

### SUMMARY OF THE INVENTION

The invention is directed to electric power generation and more particularly, to a trinity hydro-pneumatic power source, which does not rely solely on hydraulics to generate rotational motion.

In one general aspect of the present invention, a trinity hydro-pneumatic power source includes a turbine to convert hydraulic energy into mechanical rotation energy.

In another aspect of the present invention, the trinity hydro-pneumatic power source includes three hydro-pneumatic pressure tanks that are used to produce a stream of water, which forces the turbine to rotate.

In a further aspect of the present invention, the trinity hydro-pneumatic power source includes a pneumatic pressure tank that is used to force water out of the three hydro-pneumatic pressure tanks.

In yet a further aspect of the present invention, the trinity hydro-pneumatic power source includes a vacuum pump for creating a vacuum in the three hydro-pneumatic pressure tanks, before they are filled with water.

In yet a further aspect of the present invention, the trinity hydro-pneumatic power source includes a compression pump for building-up air pressure in the pneumatic pressure tank.

In yet a further aspect of the present invention, the trinity hydro-pneumatic power source includes a pressure accumulator tank to build pressure before transfer to the pneumatic pressure tank.

In yet a further aspect of the present invention, the trinity hydro-pneumatic power source includes a plurality of valves for regulating the flow of air and water.

In yet a further aspect of the present invention, the trinity hydro-pneumatic power source includes a valve controller for controlling the operation of the plurality of valves.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a schematic diagram of a trinity hydro-pneumatic power source;

FIG. 2 is a schematic diagram of a trinity hydro-pneumatic power source utilizing a first hydro-pneumatic tank for driving the turbine;

FIG. 3 is a schematic diagram of a trinity hydro-pneumatic power source utilizing a third hydro-pneumatic tank for driving the turbine; and

FIG. 4 is a schematic diagram of a trinity hydro-pneumatic power source utilizing a second hydro-pneumatic tank for driving the turbine.

Like reference numerals refer to like parts throughout the several views of the drawings.

### DETAILED DESCRIPTION OF THE PREFERRED EMBODIMENTS

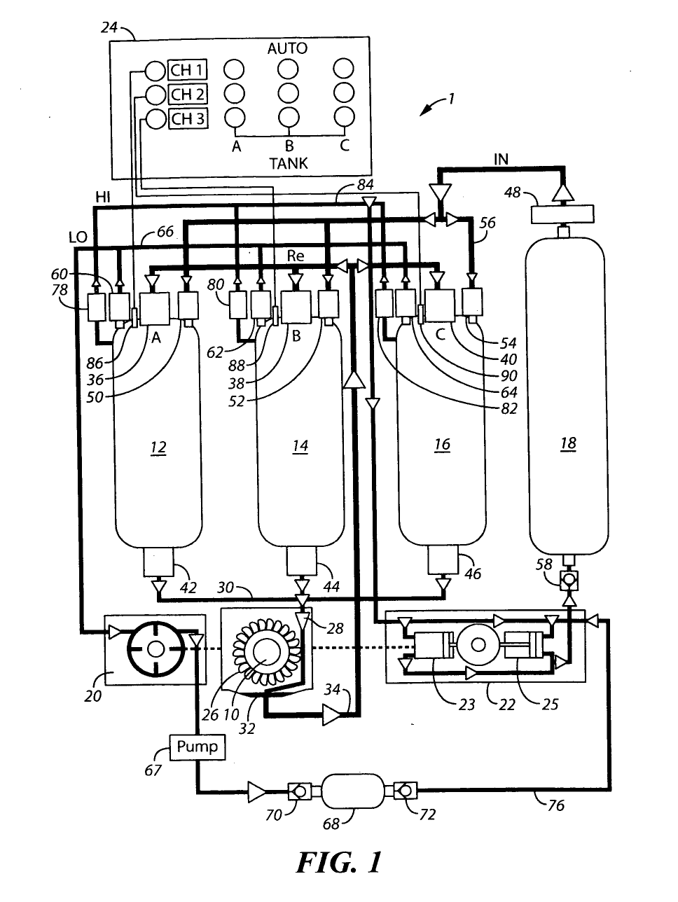

Shown throughout the figures, the present invention is generally directed to a trinity hydro-pneumatic power source 1. Referring briefly to FIG. 1, the trinity hydro-pneumatic power source 1 preferably includes a turbine 10, three hydro-pneumatic pressure tanks 12, 14, 16, a pneumatic pressure tank 18, a vacuum pump 20, a compression pump 22 and a valve controller 24. The turbine 10 is preferably a Pelton type of turbine, but other types of turbines may also be used. The turbine 10 includes a plurality of water cups 26 formed around a perimeter thereof. The water cups are optimized to receive a flow of pressurized water through a water nozzle 28. The water nozzle 28 receives-pressurized water from one of the three hydro-pneumatic pressure tanks 12, 14, 16 through a nozzle manifold tube 30. Water dispensed from water nozzle 28 is used to rotate turbine 10. A water collection pan 32 is positioned below the turbine 10 to collect water the dispensed water. The water received in the collection pan 32 is used to fill one of the three hydro-pneumatic pressure tanks 12, 14, 16 through a fill manifold 34 (also labeled “Re”, for Released Water).

Water valves 36, 38, 40 control the flow of water from the fill manifold 34 into the inlets of the three hydro-pneumatic pressure tanks 12, 14, 16, respectively. Release valves 42, 44, 46 are disposed between an outlet of the three hydro-pneumatic pressure tanks 12, 14, 16, respectively and the nozzle manifold tube 30. Pressurized air in the pneumatic pressure tank 18 is used force water out of the three hydro-pneumatic pressure tanks 12, 14, 16 to drive the turbine 10. A pressure control valve 48 opens and closes an outlet of the pneumatic pressure tank 18. Pressure inlet valves 50, 52, 54 open and close a pressurized air inlet of the three hydro-pneumatic pressure tanks 12, 14, 16. An air pressure manifold 56 (also labeled “IN”, for intake) is connected between the pressure inlet valves 50, 52, 54 and the pressure control valve 48. A pressure check valve 58 seals an inlet of the pneumatic pressure tank 18.

The vacuum pump 20 pulls a vacuum on vacuum inlets of the three hydro-pneumatic pressure tanks 12, 14, 16 through vacuum valves 60, 62, 64, respectively. A vacuum manifold 66 (also labeled LO) is connected between the vacuum valves 60, 62, 64 and a vacuum inlet of the vacuum pump 20. A pressure accumulator tank 68 is located between the vacuum pump 20 and the pneumatic pressure tank 18. An inlet of the pressure accumulator tank 68 is sealed with an inlet accumulator check valve 70 and an outlet of the pressure accumulator tank 68 is terminated with an outlet accumulator check valve 72. The outlet of the vacuum pump 20 is coupled to the inlet accumulator check valve 70. The outlet accumulator check valve 72 is coupled to the pressure check valve 58 through an outlet accumulator pipe 76. The outlet accumulator check valve 72 is preferably set to open, when the pressure inside the pressure accumulator tank 68 is at least one third of the preferable operating pressure (1000 psi). An additional compressor pump 67 may be located between the outlet of the vacuum pump 20 and an inlet of the pressure accumulator tank 68. The additional compressor pump 67 may be used to improve the efficiency of the trinity hydro-pneumatic power source 1.

The compression pump 22 receives pressurized air from the three hydro-pneumatic pressure tanks 12, 14, 16, after water has been pushed out of one of the three hydro-pneumatic pressure tanks 12, 14, 16. The residual pressurized air is input into the pistons 23, 25 of the compression pump 22. The residual pressurized air is further compressed and output to the pneumatic pressure tank 18. Residual air pressure valves 78, 80, 82 are connected to air outlets of the three hydro-pneumatic pressure tanks 12, 14, 16, respectively. A residual air manifold 84 (also labeled HI) is connected between the residual air pressure valves 78, 80, 82 and an inlet of the pistons 23, 25.

The valve controller 24 controls the actuation of the water valves 36, 38, 40, the release valves 42, 44, 46, pressure control valve 48, the pressure inlet valves 50, 52, 54, the vacuum valves 60, 62, 64 and the residual air pressure valves 78, 80, 82. The pressure generated by the compression pump 22 is preferably 1000 psi, but other pressures may also be used.

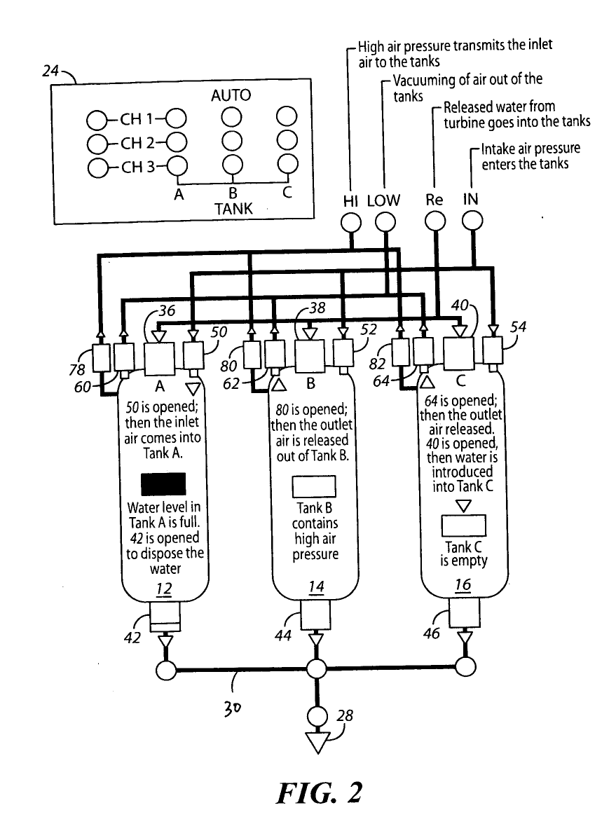

FIG. 2 illustrates the state of the three hydro-pneumatic pressure tanks 12, 14, 16 and the valves actuated by the valve controller 24, when the first hydro-pneumatic pressure tank 12 is filled with water and prior to the output of water. The first pressure valve 50, the first release valve 42 and the pressure control valve 48 are opened. The pressurized air from the pneumatic pressure tank 18 flows into the first hydro-pneumatic pressure tank 12 and forces the water to flow through the water nozzle 28. The residual pressurized air in the second hydro-pneumatic pressure tank 14 is vented to the compression pump 22 through the second residual air pressure valve 80. The third hydro-pneumatic pressure tank 16 does not contain water. The third vacuum valve 64 is opened to allow the vacuum pump 20 to put a vacuum on the third hydro-pneumatic pressure tank 16. After the third hydro-pneumatic pressure tank 16 is under vacuum, thereof is filled with water by opening the third water valve 40. The third water valve 40 is closed by the valve controller 24, when the water level actuates a third water sensor 90.

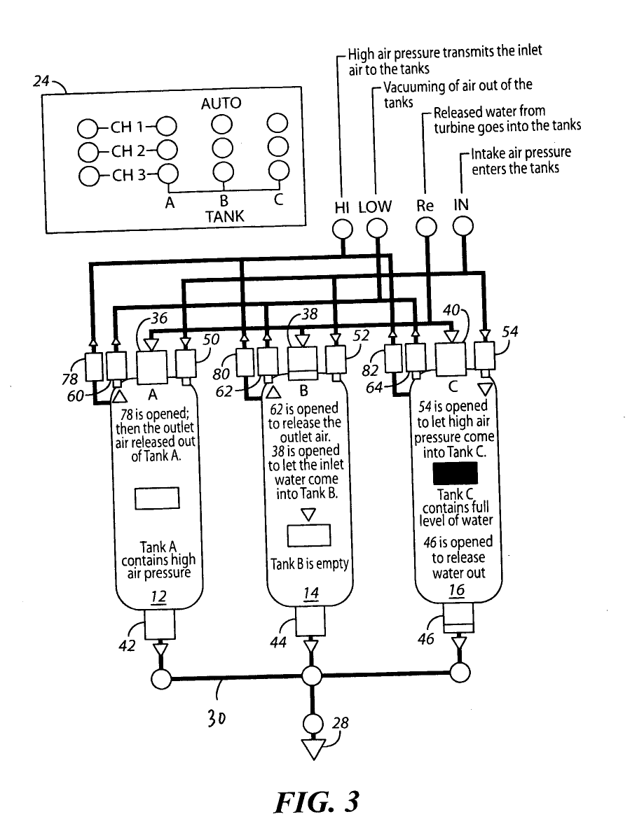

FIG. 3 illustrates the state of the three hydro-pneumatic pressure tanks 12, 14, 16 and the valves actuated by the valve controller 24, when the third hydro-pneumatic pressure tank 16 is filled with water and prior to the output of water. The third pressure valve 54, the third release valve 46, and the pressure control valve 48 are opened. The pressurized air from the pneumatic pressure tank 18 flows into the third hydro-pneumatic pressure tank 16 and forces the water to flow through the water nozzle 28. The residual pressurized air in the first hydro-pneumatic pressure tank 12 is vented to the compression pump 22 through the first residual air pressure valve 78. The second hydro-pneumatic pressure tank 14 does not contain water. The second vacuum valve 62 is opened to allow the vacuum pump 20 to put a vacuum on the second hydro-pneumatic pressure tank 14. After the second hydro-pneumatic pressure tank 14 is under vacuum, thereof is filled with water by opening the second water valve 38. The second water valve 38 is closed by the valve controller 24, when the water level actuates a second water sensor 88.

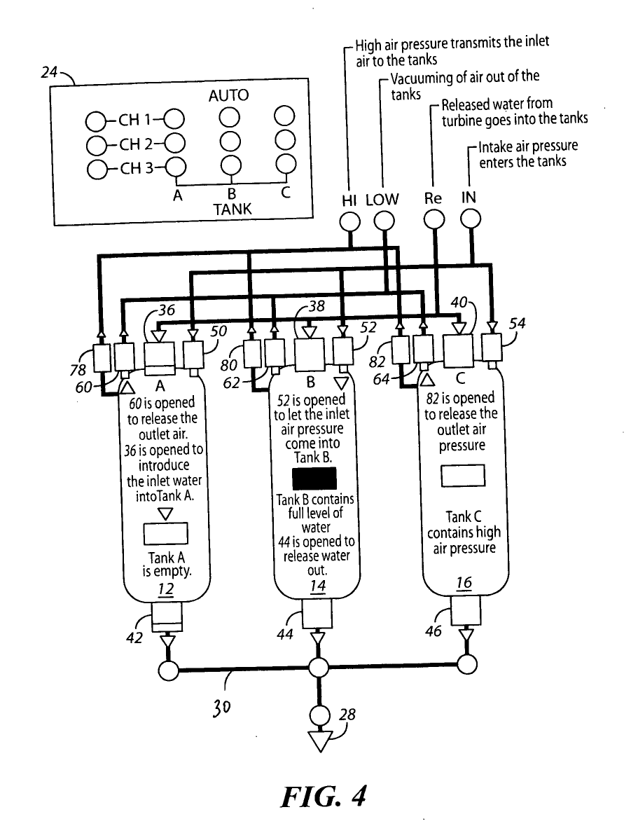

FIG. 4 illustrates the state of the three hydro-pneumatic pressure tanks 12, 14, 16 and the valves actuated by the valve controller 24, when the second hydro-pneumatic pressure tank 14 is filled with water and prior to the output of water. The second pressure valve 52, the second release valve 44 and the pressure control valve 48 are opened. The pressurized air from the pneumatic pressure tank 18 flows into the second hydro-pneumatic pressure tank 14 and forces the water to flow through the water nozzle 28. The residual pressurized air in the third hydro-pneumatic pressure tank 16 is vented to the compression pump 22 through the third residual air pressure valve 82. The first hydro-pneumatic pressure tank 12 does not contain water. The first vacuum valve 60 is opened to allow the vacuum pump 20 to pull a vacuum on the first hydro-pneumatic pressure tank 12. After the first hydro-pneumatic pressure tank 12 is under vacuum, thereof is filled with water by opening the first water valve 36. The first water valve 36 is closed by the value controller 24, when the water level actuates a first water sensor 86.

Since many modifications, variations, and changes in detail can be made to foregoing description invention, it is intended that all matters in the illustrative accompanying drawings be interpreted as determined by the appended claims, the scope of the invention should be determined by the appended claims and their legal equivalence.

1. A trinity hydro-pneumatic power source, comprising:
at least three hydro-pneumatic pressure tanks, at least one of said three hydro-pneumatic pressure tanks being filled with water;
an outlet of a pneumatic pressure tank being connected to an inlet of said at least three hydro-pneumatic pressure tanks, said pneumatic pressure tank being filled with pressurized air;
a nozzle being connected to an outlet of said at least three hydro-pneumatic pressure tanks;
a turbine being driven by an output of pressurized water from said nozzle, pressurized air from said pneumatic pressure tank being used to force the water out of at least one of said three hydro-pneumatic pressure tanks.

2. The trinity hydro-pneumatic power source of claim 1, further comprising:
a compression pump for filling said pneumatic pressure tank with pressurized air.

3. The trinity hydro-pneumatic power source of claim 1, further comprising:
a vacuum pump for putting a vacuum on said at least three hydro-pneumatic tanks before thereof are filled with water.

4. The trinity hydro-pneumatic power source of claim 3, further comprising:
a pressure accumulator tank for accumulating pressurized air output from said vacuum pump.

5. The trinity hydro-pneumatic power source of claim 1, wherein said turbine further comprises a Pelton turbine.

6. The trinity hydro-pneumatic power source of claim 1, further comprising:
a plurality of valves particularly configured for controlling the flow of pressurized air and water.

7. The trinity hydro-pneumatic power source of claim 6, further comprising:
a valve controller for actuating said plurality of valves.

8. A trinity hydro-pneumatic power source, comprising:
at least three hydro-pneumatic pressure tanks, at least one of said three hydro-pneumatic pressure tanks being filled with water;
a vacuum pump for pulling a vacuum on said at least three hydro-pneumatic tanks before said tanks are filled with water;
an outlet of a pneumatic pressure tank connected to an inlet of said at least three hydro-pneumatic pressure tanks, said pneumatic pressure tank being filled with pressurized air;
a nozzle connected to an outlet of said at least three hydro-pneumatic pressure tanks; and
a turbine driven by an output of pressurized water from said nozzle, pressurized air from said pneumatic pressure tank being used to force the water out of at least one of said three hydro-pneumatic pressure tanks.

9. The trinity hydro-pneumatic power source of claim 8, further comprising:
a compression pump for filling said pneumatic pressure tank with pressurized air.

10. The trinity hydro-pneumatic power source of claim 8, further comprising:
a pressure accumulator tank for accumulating pressurized air output from said vacuum pump.

11. The trinity hydro-pneumatic power source of claim 8, wherein said turbine further comprises a Pelton turbine.

12. The trinity hydro-pneumatic power source of claim 8, further comprising a plurality of valves for controlling the flow of pressurized air and water.

13. The trinity hydro-pneumatic power source of claim 12, further comprising a valve controller for actuating said plurality of valves.

14. A method of creating a power source utilizing pneumatic and hydraulic energy, comprising the steps of:
filling at least one of at least three hydro-pneumatic pressure tanks with water;
filling a pneumatic pressure tank with pressurized air, connecting an outlet of said pneumatic pressure tank to an inlet of said at least three hydro-pneumatic pressure tanks;
connecting a nozzle to an outlet of said at least three hydro-pneumatic pressure tanks, releasing pressurized air from said pneumatic pressure tank into at least one of said at least three hydro-pneumatic pressure tanks, said pressurized air causing water to be forced out of at least one of said at least three hydro-pneumatic pressure tanks through said nozzle; and
driving a turbine with water from said nozzle.

15. The method of creating a power source utilizing pneumatic and hydraulic energy of claim 14, further comprising the step of filling said pneumatic pressure tank with pressurized air from a compressor pump.

16. The method of creating a power source utilizing pneumatic and hydraulic energy of claim 14, further comprising the step of providing a vacuum pump for pulling a vacuum on said at least three hydro-pneumatic tanks before said tanks are filled with water.

17. The method of creating a power source utilizing pneumatic and hydraulic energy of claim 16, of providing a pressure accumulator tank for accumulating pressurized vacuum pump.

18. The method of creating a power source utilizing pneumatic and hydraulic energy of claim 14, further comprising the step of providing a Pelton turbine for said turbine.

19. The method of creating source utilizing pneumatic and hydraulic energy of claim 14, further comprising the step of controlling the flow of pressurized air and water with a plurality of valves.

20. The method of creating source utilizing pneumatic and hydraulic energy of claim 19, further comprising the step of providing a valve controller for actuating said plurality of valves.
